(19) United States
(12) Patent Application Publication
(10) Pub. No.: US 2011/0226922 A1
(43) Pub. Date: Sep. 22, 2011

(54) SUCTION CUP DEVICE

(75) Inventors: Takashi ISHIZAKI, Fujieda-city (JP); Yoshitsugu NONAKA, Fujieda-city (JP); Keiichiro OOISHI, Shizuoka-city (JP)

(73) Assignee: MURAKAMI CORPORATION, Shizuoka (JP)

(21) Appl. No.: 12/728,719

(22) Filed: Mar. 22, 2010

(51) Int. Cl. F16B 47/00

(52) U.S. Cl. 248/363

(57) ABSTRACT

A suction cup device includes a suction cup, an adhesive polymer gel layer mounted to a suction surface of the suction cup and a case. A suction surface of the polymer gel layer includes a region on an outer peripheral side and a region on an inner peripheral side placed in a position deeper than an extending surface of the region on the outer peripheral side. The case includes, on an inner surface thereof, a rib formed into an annular shape concentric with the suction cup. The rib faces the region on the outer peripheral side of the polymer gel layer from the back surface of the suction cup. When the suction cup mounted with the polymer gel layer is in the suction state, the rib presses and abuts against the back surface of the suction cup by the negative pressure, and presses the region on the outer peripheral side of the polymer gel layer via the suction cup.

### BACKGROUND OF THE INVENTION

1. Field of the Invention

The present invention relates to a suction cup device that includes an adhesive polymer gel layer mounted to a suction surface of a suction cup, and can prevent air from flowing into a suction space and maintain a suction state for a long period even if irregularities such as grain are on a surface to be sucked. The present invention also relates to a suction cup device that allows the polymer gel layer to be easily removed from the surface to be sucked and prevents the polymer gel layer from being removed from the suction surface of the suction cup, when the suction cup device in the suction state is removed from the surface to be sucked.

2. Description of the Related Art

A suction cup device including an adhesive polymer gel layer placed on a suction surface is described in US2007/246621A1. This suction cup device includes a suction cup including a polymer gel layer mounted to the suction surface by two-color molding or an adhesive, a shaft formed to protrude on a central portion on a back surface of the suction cup, a case having a shaft insertion hole, and a lock lever. The case is placed over the back surface of the suction cup with the shaft inserted through the shaft insertion hole. The lock lever applies a force between the case and the shaft and is displaced between a state where the shaft is raised with respect to the case and the suction cup mounted with the polymer gel layer is in suction contact with a surface to be sucked such as a dashboard of a vehicle firmly, and a state where the shaft is lowered with respect to the case and the suction cup is easily removed from the surface to be sucked.

As to the suction cup device described in US2007/246621A1, when the suction cup with the polymer gel layer is in suction contact with a surface to be sucked having fine irregularities such as a grain surface of a vehicle dashboard, outside air easily flows into a suction space formed between a central portion on the suction surface of the polymer gel layer and the surface to be sucked through a gap in the irregularities, which reduces a suction durability (an ability to maintain a suction state). Also, when the suction cup device in the suction state is removed from the surface to be sucked, it is difficult to remove the polymer gel layer from the surface to be sucked. Particularly, in case the suction cup device has a structure in which the polymer gel layer is bonded to the suction surface of the suction cup by an adhesive or a double-sided adhesive tape, the polymer gel layer tends to be removed from the suction surface of the suction cup and remain on the surface to be sucked.

The present invention is achieved in view of the above-described circumstances, and has an object to provide a suction cup device that can prevent air from flowing into a suction space and maintain a suction state for a long period even if irregularities such as grain are on a surface to be sucked. The present invention has another object to provide a suction cup device that allows the polymer gel layer to be easily removed from the surface to be sucked and prevents the polymer gel layer from being removed from the suction surface of the suction cup, when the suction cup device in the suction state is removed from the surface to be sucked.

### SUMMARY OF THE INVENTION

The present invention provides a suction cup device including: a suction cup; an adhesive polymer gel layer mounted to a suction surface of the suction cup; a shaft formed to protrude on a center portion on a back surface of the suction cup; a case having a shaft insertion hole; and a lock lever, the case being placed over the back surface of the suction cup with the shaft inserted through the shaft insertion hole, and the lock lever applying a force between the case and the shaft and being displaced between a state where the shaft is raised with respect to the case and the suction cup mounted with the polymer gel layer is in suction contact with the surface to be sucked firmly, and a state where the shaft is lowered with respect to the case and the suction cup mounted with the polymer gel layer is easily removed from the surface to be sucked, wherein the suction surface of the polymer gel layer includes a region on an outer peripheral side and a region on an inner peripheral side placed in a position deeper than an extending surface of the region on the outer peripheral side in a free state where the suction surface of the polymer gel layer is not in contact with the surface to be sucked, the case includes, on an inner surface thereof, a rib formed into an annular shape concentric with the suction cup to protrude toward the back surface of the suction cup, the rib faces the region on the outer peripheral side of the polymer gel layer from the back surface of the suction cup, and when the suction cup mounted with the polymer gel layer is in the suction state with respect to the surface to be sucked, a suction space is formed between the region on the inner peripheral side of the polymer gel layer and the surface to be sucked, the region on the outer peripheral side of the polymer gel layer is brought into contact with the surface to be sucked by negative pressure generated in the suction space, the rib presses and abuts against the back surface of the suction cup by the negative pressure, and presses the region on the outer peripheral side of the polymer gel layer in contact with the surface to be sucked via the suction cup.

According to the present invention, the suction surface of the polymer gel layer includes the region on the outer peripheral side and the region on the inner peripheral side placed in the position deeper than the extending surface of the region on the outer peripheral side in the free state where the suction surface of the polymer gel layer is not in contact with the surface to be sucked, and thus a region where the suction surface of the polymer gel layer firmly abuts against the surface to be sucked by the negative pressure in the suction space can be limited in a state where the suction cup is in suction contact with the surface to be sucked. This can increase contact pressure per unit area of the region where the suction surface of the polymer gel layer firmly abuts against the surface to be sucked, and thus even if irregularities such as grain are formed in the surface to be sucked, the polymer gel layer can be pressed deep into grooves of the irregularities to prevent air from flowing into the suction space and maintain the suction state for a long period. Particularly, the annular rib formed on the case presses and abuts against the back surface of the suction cup by the negative pressure generated in the suction space, and presses the region on the outer peripheral side of the polymer gel layer in contact with the surface to be sucked via the suction cup, thereby further increasing airtightness of the region on the outer peripheral side and allowing the suction state to be maintained for a longer period.

In the present invention, the suction surface of the polymer gel layer may include a connecting part connecting the region on the outer peripheral side and the region on the inner peripheral side therebetween. This allows the region on the outer peripheral side and the region on the inner peripheral side to be clearly defined by the connecting part.

In the present invention, the region on the outer peripheral side and the region on the inner peripheral side may be constituted by, for example, spherical surfaces having a common center position and such radii that a radius of the region on the inner peripheral side is larger than a radius of the region on the outer peripheral side, on both side positions across the connecting part. This allows the region on the outer peripheral side and the region on the inner peripheral side to be defined without changing curvatures.

In the present invention, the region on the inner peripheral side may include a region closer to the region on the outer peripheral side, and a region placed in a position inner than the region closer to the region on the outer peripheral side and deeper than an extending surface of the region closer to the region on the outer peripheral side in a free state where the suction surface of the polymer gel layer is not in contact with the surface to be sucked. According to this, the region on the inner peripheral side includes the region placed in the deeper position, thereby allowing the suction space to be clearly formed.

In the present invention, the rib may press an outermost peripheral position or its vicinity of the region on the outer peripheral side of the polymer gel layer in contact with the surface to be sucked via the suction cup. According to this, the rib can firmly press an air inlet or its vicinity in the region on the outer peripheral side that prevents air from flowing into the suction space against the surface to be sucked, thereby allowing the suction state to be maintained for a longer period.

If the suction cup device of the present invention is of a type in which the polymer gel layer is bonded to the suction surface of the suction cup, for example, it may be conceivable that shapes for forming the region on the outer peripheral side and the region on the inner peripheral side of the polymer gel layer are formed in the suction surface of the suction cup, a flat polymer gel layer is bonded to the suction surface of the suction cup, and thus the shape of the suction cup is reflected to form the region on the outer peripheral side and the region on the inner peripheral side of the polymer gel layer. According to this, the region on the outer peripheral side and the region on the inner peripheral side can be formed using a flat polymer gel layer.

In the present invention, the suction surface of the polymer gel layer may include a warped region warped toward a back surface of the polymer gel layer on a further outer peripheral side of the region on the outer peripheral side, and the warped region may be held away from the surface to be sucked when the suction cup mounted with the polymer gel layer is in the suction state with respect to the surface to be sucked. According to this, the warped portion of the polymer gel layer is raised from the surface to be sucked when the suction cup mounted with the polymer gel layer is in the suction state, and thus when the suction cup device is removed from the surface to be sucked, the polymer gel layer can be easily removed from the surface to be sucked. Furthermore, when the suction cup device is of the type in which the polymer gel layer is bonded to the suction surface of the suction cup, the polymer gel layer is prevented from being removed from the suction cup when the suction cup device is removed from the surface to be sucked.

### BRIEF DESCRIPTION OF THE DRAWINGS

FIG. 1 is a partial sectional view of an on-vehicle monitor support device in FIG. 2 showing a structure in a free state in which a suction surface of a polymer gel sheet is not in contact with a surface to be sucked.

FIG. 2 is a perspective view showing an embodiment of a suction cup device of the present invention applied to the on-vehicle monitor support device, and a state where the on-vehicle monitor support device is mounted to the surface to be sucked.

FIG. 3 is an exploded perspective view of the on-vehicle monitor support device in FIG. 2.

FIG. 4 is a bottom view of an inner structure of a case in FIG. 3.

FIG. 5 is a sectional view of the on-vehicle monitor support device in FIG. 2 showing a state where a lock lever is raised to an erect position, and the on-vehicle monitor support device is placed on the surface to be sucked such as a dashboard.

FIG. 6 is a sectional view showing a state where the lock lever is pressed down from the state in FIG. 5 to release air in a suction space.

FIG. 7 is a sectional view showing a state where the lock lever is tilted from the state in FIG. 6 to a laid position, a suction cup with the polymer gel sheet is in suction contact with (sucked to) the surface to be sucked, and the on-vehicle monitor support device is mounted to the surface to be sucked.

### DETAILED DESCRIPTION OF THE PREFERRED EMBODIMENT

An embodiment of the present invention will be described. In this embodiment, a suction cup device of the present invention applied to an on-vehicle monitor support device will be described. The on-vehicle monitor support device is used for mounting and supporting a monitor device such as a car navigation system or an on-vehicle television on a dashboard or the like of a vehicle.

First, with reference to FIG. 2, the outline of the on-vehicle monitor support device 10 will be described. In FIG. 2, the on-vehicle monitor support device 10 includes a base portion 12, a rotating portion 14, and a monitor mounting portion 16. The base portion 12 is mounted to a position (dashboard or the like) on which a monitor device is to be provided inside an automobile, using a suction cup with a polymer gel layer included in the base portion 12. The rotating portion 14 is connected to and supported by the base portion 12 rotatably within an angle range of 90° or more around a rotation axis 18. The rotation axis 18 is placed in parallel with a plane including a lower opening end surface 26k of a case 26 of the base portion 12. The monitor mounting portion 16 includes a fixing base 24 connected to and supported by a front end of the rotating portion 14 rotatably within an angle range of 90° or more around a rotation axis 20. The rotation axis 20 is placed in parallel with the rotation axis 18. To a front surface 24a of the fixing base 24, a monitor device 25 is removably mounted such as a liquid crystal display that constitutes a display device of a car navigation system or an on-vehicle television.

According to the above-described configuration, with the base portion 12 being mounted on a surface to be sucked 35 such as a dashboard by the suction cup with the polymer gel layer, the rotating portion 14 is manually rotated around the rotation axis 18 to adjust a height position of the monitor device 25. At this time, the rotating portion 14 is held at an adjusted rotation angle with respect to the base portion 12 by a friction force at a connecting portion between the base portion 12 and the rotating portion 14. The fixing base 24 is manually rotated around the rotation axis 20 to adjust a vertical angle of the monitor device 25. At this time, the fixing base 24 is held at an adjusted rotation angle with respect to the rotating portion 14 by a friction force at a connecting portion between the rotating portion 14 and the fixing base 24.

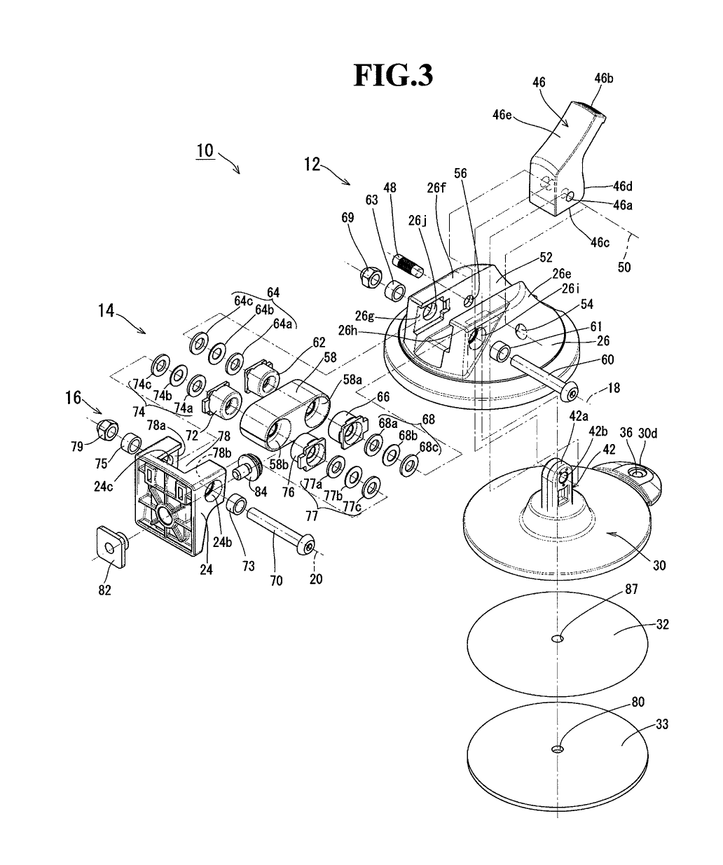

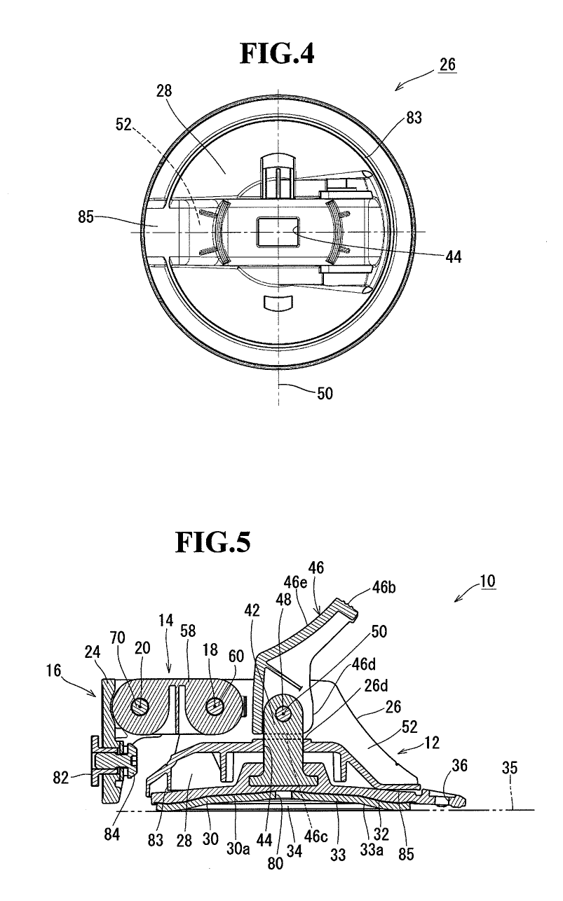

Next, detailed configurations of components of the on-vehicle monitor support device 10 will be described with reference to the drawings. In FIG. 7 showing a suction state, the base portion 12 includes a case 26 made of hard synthetic resin, metal, or the like and having high rigidity. The case 26 has an outer shape like the shape of an inverted bowl, a circular plane shape (FIG. 4), and a recess 28 opening downward. The case 26 houses a suction cup 30 in the recess 28 and is placed over a back surface of the suction cup 30. A suction surface 30a of the suction cup 30 faces the surface to be sucked 35 under the suction surface 30a. The suction cup 30 is made of, for example, rubber or elastic plastic. To the entire suction surface 30a of the suction cup 30, a polymer gel sheet 33 as an adhesive polymer gel layer is bonded by a double-sided adhesive tape 32 (FIG. 3) or an adhesive. The suction cup 30 to which the polymer gel sheet 33 is bonded is in suction contact with the surface to be sucked 35 such as a dashboard by a suction cup action. At this time, the polymer gel sheet 33 adheres to the surface to be sucked 35, holds a suction force by the suction cup 30, and maintains the suction state for a long period.

In FIG. 7, a tongue portion 30d (FIG. 3) is formed to laterally protrude from a part of a peripheral edge of the suction cup 30. The tongue portion 30d protrudes outside the case 26. The tongue portion 30d is used for removing the on-vehicle monitor support device 10 from the surface to be sucked 35. Specifically, from the state in FIG. 7 where the suction cup 30 is in suction contact with the surface to be sucked 35, a lock lever 46 is raised and then the tongue portion 30d is pinched with fingers and raised, a part of an outer peripheral edge of the suction cup 30 is removed from the surface to be sucked 35 together with the polymer gel sheet 33, air flows therefrom into a suction space 34 between the surface to be sucked 35 and the polymer gel sheet 33, suction by the suction cup 30 is released, and the on-vehicle monitor support device 10 is removed from the surface to be sucked 35. A through hole 36 is formed in a central portion of the tongue portion 30d. Into the through hole 36, a screw for securing the tongue portion 30d to the surface to be sucked 35 is inserted, as required.

In FIG. 7, a disk 40 made of hard synthetic resin, metal, or the like is embedded in a central portion of the suction cup 30. On a upper surface of a central portion of the disk 40, a shaft 42 having a flat cross sectional shape is formed integrally with the disk 40 to protrude upward. The shaft 42 is inserted through a hole 44 formed in an upper central portion of the case 26 movably in an axial direction of the shaft 42 and protrudes upward of the case 26.

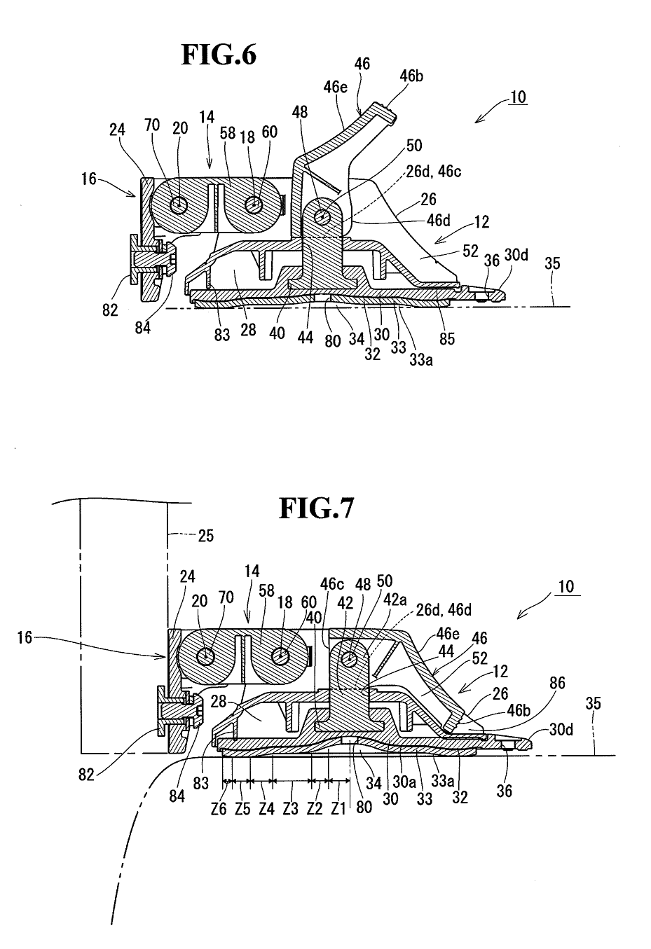

In FIG. 7, the lock lever 46 is rotatably connected by pin connection with a pin 48 to an upper portion of a protruding portion 42a of the shaft 42 protruding from the hole 44 in the case 26. Thus, the lock lever 46 is manually rotatable around a rotation axis 50 passing through the center of the pin 48. This rotation causes the lock lever 46 to be displaced between a laid position (lock position) (position in FIGS. 2 and 7) where the lock lever 46 is laid on the case 26 and an erect position (unlock position) (position in FIGS. 5 and 6) where the lock lever 46 is raised. The rotation axis 50 is placed in parallel with the rotation axes 18 and 20. The lock lever 46 moves the shaft 42 up and down with respect to the case 26 by abutment by cam engagement between a cam surface 46d (FIG. 5) formed at a base end of the lock lever 46 and a central portion 26d of the upper surface of the case 26. Specifically, when the lock lever 46 is manually operated and displaced to the laid position, the cam surface 46d abuts against the central portion 26d of the upper surface of the case 26, the shaft 42 is raised with respect to the case 26, and the suction cup 30 is put into suction contact with the surface to be sucked 35 firmly and held. When the lock lever 46 is manually operated and displaced to the erect position, the abutment between the cam surface 46d and the central portion 26d of the upper surface of the case 26 is released, the shaft 42 is lowered with respect to the case 26, and the suction cup 30 can be easily removed from the surface to be sucked 35.

In FIG. 3, on the upper portion of the case 26, a pair of protrusions 26e and 26f are formed integrally with the case 26 to protrude to face each other with the protruding portion 42a of the shaft 42 placed therebetween. The lock lever 46 is stored in a space 52 between the pair of protrusions 26e and 26f in the laid position. At this time, a surface 46e of the lock lever 46 forms a surface continuous with surfaces of the pair of protrusions 26e and 26f (FIG. 2).

In FIG. 3, pin insertion holes 54 and 56 are formed in side surfaces of the pair of protrusions 26e and 26f. The pin insertion holes 54 and 56 are formed so that the pin 48 for pin connection between the shaft 42 and the lock lever 46 is inserted through the pin insertion holes 54 and 56. Specifically, in assembly of the on-vehicle monitor support device 10, with a pin placing hole 42b in the shaft 42, a pin placing hole 46a in the lock lever 46, and the pin insertion holes 54 and 56 in the pair of protrusions 26e and 26f being coaxially arranged, the pin 48 is inserted through the pin insertion hole 56 from outside the protrusion 26f, and housed in the pin placing holes 42b and 46a in the shaft 42 and the lock lever 46. This provides the pin connection between the shaft 42 and the lock lever 46 by the pin 48.

In FIG. 7, in the space 52 housing the lock lever 46, a base end of a swing arm 58 that constitutes the rotating portion 14 is housed in a position on the side opposite to the position where the lock lever 46 is placed in a longitudinal direction of the space 52. The swing arm 58 and the lock lever 46 are placed on the opposite sides each other with respect to a center position of the case 26. The swing arm 58 is supported by the pair of protrusions 26e and 26f with a screw 60 rotatably around the rotation axis 18 (FIG. 3). Specifically, as shown in FIG. 3, the swing arm 58 houses a bush 62 in an opening portion on one side of a hole 58a formed in the base end, and a flat washer 64a, a Belleville spring 64b, and a flat washer 64c are stacked and housed in a recess in a surface of the bush 62 (a laminate of the three rings is denoted by reference numeral 64). A bush 66 is housed in an opening portion on the other side of the hole 58a, and a flat washer 68a, a Belleville spring 68b, and a flat washer 68c are stacked and housed in a recess in a surface of the bush 66 (a laminate of the three rings is denoted by reference numeral 68). In this state, the base end of the swing arm 58 is laterally slid into the space 52 between the pair of protrusions 26e and 26f. At this time, rectangular outer portions of the bushes 62 and 66 are non-rotatably housed in rectangular recesses 26g and 26h formed in an inner surface of the space 52. In this state, the screw 60 is inserted from outside the protrusion 26e through a ring 61, a hole 26i formed in a side surface of the protrusion 26e, the laminate 68 of the three rings, the bush 66, the hole 58a in the swing arm 58, the bush 62, the laminate 64 of the three rings, and a hole 26j formed in a side surface of the protrusion 26f to protrude outside the hole 26j, a ring 63 is fitted on a protruding end of the screw 60 and a nut 69 is screwed on the screw 60, and thus the swing arm 58 is connected to the pair of protrusions 26e and 26f rotatably around the rotation axis 18. A screwing force of the screw 60 into the nut 69 can adjust running torque (friction force) of the swing arm 58 with respect to the pair of protrusions 26e and 26f.

In FIG. 3, the fixing base 24 is supported at a front end of the swing arm 58 with a screw 70 rotatably around the rotation axis 20. Specifically, a bush 72 is housed in an opening portion on one side of a hole 58b formed in the front end of the swing arm 58, and a flat washer 74a, a Belleville spring 74b, and a flat washer 74c are stacked and housed in a recess in a surface of the bush 72 (a laminate of the three rings is denoted by reference numeral 74). A bush 76 is housed in an opening portion on the other side of the hole 58b, and a flat washer 77a, a Belleville spring 77b, and a flat washer 77c are stacked and housed in a recess in a surface of the bush 76 (a laminate of the three rings is denoted by reference numeral 77). In this state, the front end of the swing arm 58 is slid into a space 78 formed in a back surface of the fixing base 24. At this time, rectangular outer portions of the bushes 72 and 76 are non-rotatably housed in rectangular recesses 78a and 78b formed in an inner surface of the space 78. In this state, the screw 70 is inserted from outside the fixing base 24 through a ring 73, a hole 24b formed in a side surface of the fixing base 24, the laminate 77 of the three rings, the bush 76, the hole 58b in the swing arm 58, the bush 72, the laminate 74 of the three rings, and a hole 24c formed in a side surface of the fixing base 24 to protrude outside the hole 24c, a ring 75 is fitted on a protruding end of the screw 70 and a nut 79 is screwed on the screw 70, and thus the fixing base 24 is connected to the front end of the swing arm 58 rotatably around the rotation axis 20. A screwing force of the screw 70 into the nut 79 can adjust running torque (friction force) of the fixing base 24 with respect to the swing arm 58. On the front surface 24a of the fixing base 24, a jig 82 for mounting the monitor device is mounted by a screw 84 from a back surface.

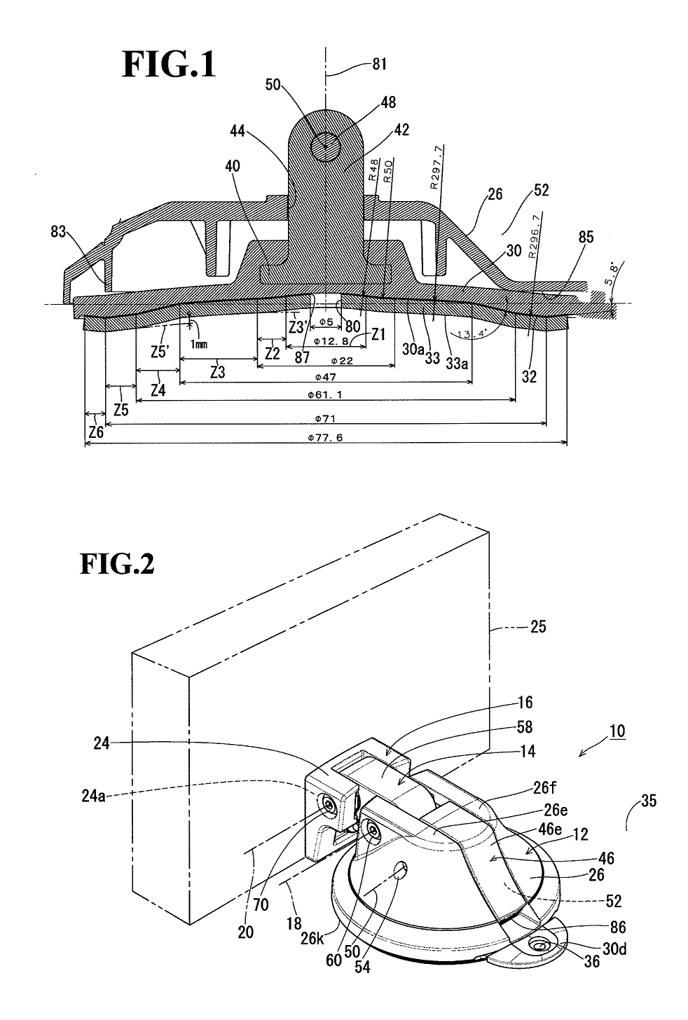

Next, detailed structures of the suction cup 30 and the polymer gel sheet 33 will be described. FIG. 1 shows a sectional structure of the suction cup 30, the polymer gel sheet 33, and the case 26. The structure is in a free state where the suction surface 33a of the polymer gel sheet 33 is not in contact with the surface to be sucked. The entire surface of the circular polymer gel sheet 33 is bonded to the suction surface 30a of the circular suction cup 30 by the double-sided adhesive tape 32 (FIG. 3). A relief shape (irregularities) to be formed in the suction surface 33a of the polymer gel sheet 33 is formed in the suction surface 30a of the suction cup 30. The polymer gel sheet 33 is originally formed of a flat sheet (having a diameter of 77.6 mm in this example) having a uniform thickness (2 mm in this example), the sheet is bonded to the suction surface 30a of the suction cup 30 (having a diameter of 81.2 mm in this example), thus the relief shape in the suction surface 30a of the suction cup 30 is directly reflected on the suction surface 33a of the polymer gel sheet 33, and the relief shape is formed in the suction surface 33a of the polymer gel sheet 33. Instead of forming the relief shape in the suction surface 30a of the suction cup 30, the thickness of the polymer gel sheet 33 may be changed depending on radial positions to directly form a relief shape in the suction surface 33a. The suction surface 30a of the suction cup 30 is constituted by a surface including circular (ring-shaped) regions Z1 to Z6 in FIG. 1 successively connected without steps and forms the relief shape. Structures of the regions Z1 to Z6 are as described below.

Region Z1: An innermost peripheral region to a diameter of 12.8 mm. A circular through hole 80 having a diameter of 5 mm and reaching the surface of the suction cup 30 is formed at the center. This region is constituted by a spherical surface having a radius of 48 mm with the center on a central axis 81 of the suction cup 30. A circular through hole 87 (FIG. 3) having a diameter of 5 mm and communicating with the through hole 80 is also formed in the double-sided adhesive tape 32, and the center of the suction surface 30a of the suction cup 30 is exposed to outside air through the through holes 80 and 87.

Region Z2: A region from an outermost peripheral position of the region Z1 to a diameter of 22 mm. This region is constituted by a spherical surface having a radius of 50 mm with the center on the central axis 81 of the suction cup 30.

Region Z3: A region from an outermost peripheral position of the region Z2 to a diameter of 47 mm. This region is constituted by a spherical surface having a radius of 297.7 mm with the center on the central axis 81 of the suction cup 30.

Region Z4: A region from an outermost peripheral position of the region Z3 to a diameter of 61.1 mm. This region is constituted by a conical surface.

Region Z5: A region from an outermost peripheral position of the region Z4 to a diameter of 71 mm. This region is constituted by a spherical surface having a radius of 296.7 mm with the center at the same position as the region Z3.

Region Z6: A region from an outermost peripheral position of the region Z5 to a diameter of 77.6 mm. This region is constituted by an inverted conical surface warped toward the back surface of the polymer gel sheet 33 at an angle of 5.8° with respect to a surface perpendicular to the central axis 81.

According to the regions Z1 to Z6 having the above-described structures, the region Z4 constitutes a connecting part connecting the region Z5 on the outer peripheral side and the region Z3 on the inner peripheral side. The region Z5 on the outer peripheral side constitutes a region that firmly abuts against the surface to be sucked 35 in the suction state, and this region mainly prevents a flow of air into the suction space 34. The region Z3 on the inner peripheral side is offset 1 mm deeper than an extending surface Z5′ (the spherical surface having a radius of 296.7 mm with the center on the central axis 81 of the suction cup 30) of the region Z5 on the outer peripheral side. The regions inner than the region Z4 include the region Z3 closer to the region Z5 on the outer peripheral side, and the region Z1 placed in a position deeper than an extending surface Z3′ of the region Z3. The region Z2 connects the region Z3 and the region Z1. The outermost peripheral region Z6 is constituted by the inverted conical surface warped toward the back surface of the polymer gel sheet 33, and is held away from the surface to be sucked 35 even when the suction cup 30 mounted with the polymer gel sheet 33 is in suction contact with the surface to be sucked 35 (FIG. 7). Thus, when the suction cup 30 mounted with the polymer gel sheet 33 is removed from the surface to be sucked 35, the polymer gel sheet 33 can be easily removed from the surface to be sucked 35, and the polymer gel sheet 33 can be prevented from being removed from the suction cup 30 and remaining on the surface to be sucked 35.

In FIG. 1, the through hole 80 formed in the region Z1 functions as an air vent hole through which air trapped between the polymer gel sheet 33 and the suction cup 30 is released when the polymer gel sheet 33 is bonded to the suction surface 30a of the suction cup 30. After the polymer gel sheet 33 is bonded to the suction surface 30a of the suction cup 30, the through hole 80 adjusts an amount of residual air in the suction space 34 depending on the capacity of the through hole 80, and sets the suction force to a desired level. Specifically, when the lock lever 46 is pressed down to release air in the suction space 34 to bring the suction cup 30 mounted with the polymer gel sheet 33 into suction contact with the surface to be sucked 35, a larger diameter of the through hole 80 increases the amount of residual air in the suction space 34, and thus a low suction force is obtained when the lock lever 46 is tilted to the laid position. On the other hand, a smaller diameter of the through hole 80 reduces the amount of residual air in the suction space 34, and thus a high suction force is obtained when the lock lever 46 is tilted to the laid position. Too high suction force makes it difficult to remove the suction cup 30 mounted with the polymer gel sheet 33 from the surface to be sucked 35. In the state where a small amount of residual air is in the suction space 34, a large operation force is required to tilt the lock lever 46 from the erect position to the laid position for suction, and tilting may be difficult. Thus, the through hole 80 of a suitable size is formed to adjust the amount of residual air. Not limited to one through hole 80, but a plurality of through holes 80 may be formed. Not limited to on the central axis 81, the through hole 80 may be formed outside the central axis 81. The size or the number of the through holes 80 can be changed to adjust the suction force.

In FIG. 1, a rib 83 protrudes on the inner surface of the case 26. The rib 83 is formed into an annular shape concentric with the suction cup 30, and protrudes toward the back surface of the suction cup 30. The rib 83 has a width (thickness) of about 1 mm. The rib 83 faces an outermost peripheral position or its vicinity of the region Z5 (having a width of about 5 mm) on the outer peripheral side of the polymer gel sheet 33, from the back surface of the suction cup 30. As shown in FIG. 4, the rib 83 is formed over the entire circumference except a region 85 that forms the space 52 for housing the lock lever 46. In the region 85 that forms the space 52 for housing the lock lever 46, the rib 83 is not formed because a height for forming the rib 83 cannot be ensured, and instead, the region 85 is constituted by a plane forming the same surface as a front end surface of the rib 83.

A procedure for mounting the on-vehicle monitor support device 10 having the above-described configuration to the surface to be sucked 35 such as a dashboard will be described. Before the on-vehicle monitor support device 10 is mounted to the surface to be sucked 35, the lock lever 46 is set to the erect position in FIG. 5. A surface 46c of the lock lever 46 faces the central portion 26d of the upper surface of the case 26 in the erect position. In this state, the on-vehicle monitor support device 10 is placed in a desired placing position on the surface to be sucked 35.

When the lock lever 46 is pinched with fingers and pressed directly downward without rotation from the state in FIG. 5 where the on-vehicle monitor support device 10 is placed in the desired position on the surface to be sucked 35, the central portion of the suction cup 30 is pressed down via the shaft 42, air in the suction space 34 between the polymer gel sheet 33 and the surface to be sucked 35 is released, and the region on the outer peripheral side of the polymer gel sheet 33 adheres to the surface to be sucked 35. FIG. 6 shows this state. The suction space 34 is smaller than that in the state in FIG. 5.

When the lock lever 46 is rotated to the laid position in FIG. 7 from the state in FIG. 6, the cam surface 46d of the lock lever 46 abuts against the central portion 26d of the upper surface of the case 26, the shaft 42 is raised with the central portion of the suction cup 30, and the suction space 34 between the polymer gel sheet 33 and the surface to be sucked 35 is brought under negative pressure to generate a suction force. Thus, the on-vehicle monitor support device 10 is firmly mounted to the surface to be sucked 35. When the suction space 34 is under negative pressure, the rib 83 particularly firmly presses the outermost peripheral position (specifically, an air inlet side in a pressure bonding region that prevents the flow of air into the suction space 34) or its vicinity of the region Z5 (FIG. 1) on the outer peripheral side of the polymer gel sheet 33 against the surface to be sucked 35 via the suction cup 30 and engages with the pressed position of the suction cup 30 by the negative pressure, and thus suction by the suction cup 30 is maintained for a long period. The region 85 without the rib 83 in a part of the circumferential direction is constituted by the plane continuous with the front end surface of the rib 83, and the plane presses the polymer gel sheet 33 against the surface to be sucked 35, and thus the region 85 also prevents the flow of air into the suction space 34.

The lock lever 46 is stored in the space 52 between the pair of protrusions 26e and 26f in the laid position (FIG. 2), and the surface 46e of the lock lever 46 forms the surface continuous with the surfaces of the pair of protrusions 26e and 26f. Thus, the base portion 12 has few irregularities in the surface, and has high safety and good design.

With the on-vehicle monitor support device 10 being mounted to the surface to be sucked 35, a driver or the like can manually rotate the swing arm 58 around the rotation axis 18 to adjust the height position of the monitor device 25. Also, the driver or the like can manually rotate the monitor mounting portion 16 around the rotation axis 20 to adjust the vertical angle of the monitor device 25. Thus, by cooperation between the rotation of the swing arm 58 around the rotation axis 18 and the rotation of the monitor mounting portion 16 around the rotation axis 20, the height position of the monitor device 25 can be adjusted with the monitor device 25 being maintained in a predetermined angle with respect to the surface to be sucked 35. When the on-vehicle monitor support device 10 is removed from the surface to be sucked 35, a finger is inserted into a gap 86 (FIGS. 2 and 7) between the front end 46b of the lock lever 46 and the case 26 and hooked at the front end 46b of the lock lever 46 to raise the lock lever 46. Then, the tongue portion 30d is pinched with fingers and slowly raised. Thus, a part of the outer peripheral edge of the suction cup 30 is removed from the surface to be sucked 35 together with the polymer gel sheet 33, air flows therefrom into the suction space 34 between the surface to be sucked 35 and the polymer gel sheet 33, suction by the suction cup 30 is released, and the on-vehicle monitor support device 10 is removed from the surface to be sucked 35 such as a dashboard.

The invention according to claims 1 to 5 and 7 is not limited to the suction cup device of the type in which the polymer gel layer is bonded to the suction surface of the suction cup, but may be applied to a suction cup device of a type in which a polymer gel layer is mounted to a suction cup by two-color molding.

What is claimed is:

1. A suction cup device comprising:
a suction cup;
an adhesive polymer gel layer mounted to a suction surface of the suction cup;
a shaft formed to protrude on a center portion on a back surface of the suction cup;
a case having a shaft insertion hole; and
a lock lever,
the case being placed over the back surface of the suction cup with the shaft inserted through the shaft insertion hole, and the lock lever applying a force between the case and the shaft and being displaced between a state where the shaft is raised with respect to the case and the suction cup mounted with the polymer gel layer is in suction contact with the surface to be sucked firmly, and a state where the shaft is lowered with respect to the case and the suction cup mounted with the polymer gel layer is easily removed from the surface to be sucked,
wherein the suction surface of the polymer gel layer includes a region on an outer peripheral side and a region on an inner peripheral side placed in a position deeper than an extending surface of the region on the outer peripheral side in a free state where the suction surface of the polymer gel layer is not in contact with the surface to be sucked,
the case includes, on an inner surface thereof, a rib formed into an annular shape concentric with the suction cup to protrude toward the back surface of the suction cup, the rib faces the region on the outer peripheral side of the polymer gel layer from the back surface of the suction cup, and
when the suction cup mounted with the polymer gel layer is in the suction state with respect to the surface to be sucked, a suction space is formed between the region on the inner peripheral side of the polymer gel layer and the surface to be sucked, the region on the outer peripheral side of the polymer gel layer is brought into contact with the surface to be sucked by negative pressure generated in the suction space, the rib presses and abuts against the back surface of the suction cup by the negative pressure, and presses the region on the outer peripheral side of the polymer gel layer in contact with the surface to be sucked via the suction cup.

2. The suction cup device according to claim 1, wherein the suction surface of the polymer gel layer includes a connecting part connecting the region on the outer peripheral side and the region on the inner peripheral side therebetween.

3. The suction cup device according to claim 2, wherein the region on the outer peripheral side and the region on the inner peripheral side are constituted by spherical surfaces having a common center position and such radii that a radius of the region on the inner peripheral side is larger than a radius of the region on the outer peripheral side, on both side positions across the connecting part.

4. The suction cup device according to claim 1, wherein the region on the inner peripheral side includes a region closer to the region on the outer peripheral side, and a region placed in a position inner than the region closer to the region on the outer peripheral side and deeper than an extending surface of the region closer to the region on the outer peripheral side in a free state where the suction surface of the polymer gel layer is not in contact with the surface to be sucked.

5. The suction cup device according to claim 1, wherein the rib presses an outermost peripheral position or its vicinity of the region on the outer peripheral side of the polymer gel layer in contact with the surface to be sucked via the suction cup.

6. The suction cup device according to claim 1, wherein shapes for forming the region on the outer peripheral side and the region on the inner peripheral side of the polymer gel layer are formed in the suction surface of the suction cup, a flat polymer gel layer is bonded to the suction surface of the suction cup, and thus the shape of the suction cup is reflected to form the region on the outer peripheral side and the region on the inner peripheral side of the polymer gel layer.

7. The suction cup device according to claim 1, wherein the suction surface of the polymer gel layer includes a warped region warped toward a back surface of the polymer gel layer on a further outer peripheral side of the region on the outer peripheral side, and the warped region is held away from the surface to be sucked when the suction cup mounted with the polymer gel layer is in the suction state with respect to the surface to be sucked.
